(19) United States
(12) Patent Application Publication
(10) Pub. No.: US 2015/0207890 A1
(43) Pub. Date: Jul. 23, 2015

(54) USING BADGES TO INITIATE ACTIVITIES

(71) Applicant: Microsoft Corporation, Redmond, WA (US)

(72) Inventors: Scott Fynn, Seattle, WA (US); Robert Howard, Bellevue, WA (US); Blaise H. Aguera y Arcas, Seattle, WA (US)

(21) Appl. No.: 14/162,731

(22) Filed: Jan. 23, 2014

(51) Int. Cl. H04L 29/08

(52) U.S. Cl. CPC H04L 67/22; H04L 67/10

(57) ABSTRACT

Badges may be assigned to a user, and activities may be associated with the badges. The user may have the option to activate or deactivate specific activities associated with a badge, or to add additional activities in exchange for providing information about the user. A system may use the badges to initiate activities for the user. The specific choice of activities to be initiated may depend on context, where the context may include the device that is being used, where the user is located, whether the user is traveling, etc.

### BACKGROUND

Users have increasingly come to expect that software and online services will provide them with a personalized experience. For some time, users have had the ability to customize the appearance of a software application or online service, for example by specifying a particular color background, or by selecting a particular layout, or by selecting functional widgets to be displayed on a home screen. Users can also subscribe to particular notifications—e.g., they can subscribe to receive scores for a favorite sports team, or to receive news updates from a source that they trust. In these cases, however, the user is receiving a particular personalized experience because the user made an explicit choice to ask for that experience.

It is possible to predict what sort of personalized experience a user is likely to want, by inferring certain attributes about the user. For example, if a user frequently “checks in” at tapas restaurants, one can infer that the user is a tapas enthusiast. If the user attends a Seattle Mariners game once a week in the summer, it is possible to infer that the user is a Mariners fan. Some systems that have obtained user permission to analyze a user's behavior may assign a “badge” to the user based on such inferences, where the badge describes some attribute or behavioral pattern of the user. However, systems that draw these inferences and that personalize an experience based on the inferences run the risk of offending the user. Some users find it intrusive, and are left with a sense that they are secretly being “watched”, when the system customizes the experience form them in a way that appears too accurate—particularly when the users do not understand how the system determined to customize the experience in a particular way.

### SUMMARY

A user experience may be customized by associating activities with a badge, and allowing the activities to be initiated for the user. With a user's permission, a system may gather information about the user and may assign badges to the user based on that behavior. The system may then initiate activities based on the user's badges. The user may be given the opportunity to choose which activities to associate with the badge, and may also be offered additional activities in exchange for the user's providing some information about himself or herself. Moreover, different activities may be initiated based on context—e.g., the same badge might cause one activity to be initiated when the user is traveling with his smart phone, and may cause a different activity to be initiated when the user is at home using his tablet.

For example, if the user has a badge indicating that he holds a reservation on a particular flight, then activities such as “check me in” and “report on traffic” may be associated with that badge. If the user is on his way to the airport with his smart phone, the phone may initiate the “report on traffic” action. If the user is using a tablet at home (or even if the user is not presently using any device), the badge may initiate the “check me in” action.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a flow diagram of an example process in which badges may be used to initiate activities.

FIGS. 2-4 are block diagrams of example user interfaces that may be used in accordance with the systems and processes of the subject matter herein.

FIGS. 5 and 6 are block diagrams of example actions that may be initiated based on a badge.

FIG. 7 is a block diagram of example components that may be used in connection with implementations of the subject matter described herein.

### DETAILED DESCRIPTION

Users have increasingly come to expect a personalized experience when the use devices or online services. One way to personalize the user's experience is to assign badges to the user, where the badge represents some attribute of the user, a pattern of behavior, or an arbitrary fact about the user. In some cases, these attributes, patterns, and facts are self-reported by the user, while in some cases the facts are gleaned or inferred from the user's behavior (with the user's permission, in order to preserve the user's interest in privacy).

The subject matter herein associates activities with badges, and initiates those activities based on the badges that have been assigned to the user, and also based on various aspects of the current context. Based on either inference or self-reporting, a badge is assigned to the user, and certain activities may be associated with the badge. The user may be shown the badge and the associated activities, and may be given the chance to turn some of the activities on or off, or to configure the activities. The user may also be offered the chance to associate additional activities with the badge by voluntarily providing additional information about himself.

For example, the user might choose to give the system access to his patterns of checking in at retail establishments, and those patterns might indicate that the user frequents tapas restaurants. The user could then be assigned the tapas badge. The tapas badge may be associated with the activity “alert me when a tapas restaurant in nearby.” A user interface may be provided that allows the user to enable or disable this activity. The interface may also ask the user if he or she is interested in receiving tapas recipes and, if so, to turn on the “alert me to new tapas recipes” badge. In this way, the user provides information to the system about his interest in recipes, and, in exchange, gets a new activity associated with the badge. A system may initiate these activities based on the fact that the activities are associated with the badge, but also based on context. Examples of context include where the user is and what device the user is using. For example, if the user is traveling with his smart phone, then the “alert me when a tapas restaurant in nearby” activity may be initiated when the user is within one mile of a tapas restaurant. When the user is at home using a tablet in his kitchen, the “alert me to new tapas recipes” activity may be initiated.

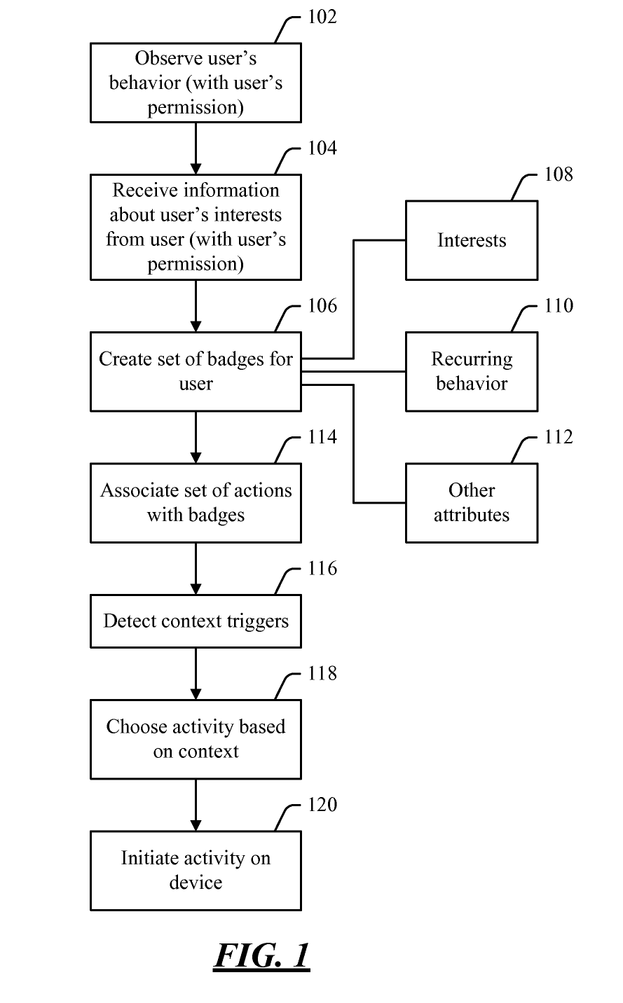

Turning now to the drawings, FIG. 1 shows an example process in which badges may be used to initiate activities. At 102, the user's behavior may be observed (pursuant to appropriate permission obtained from the user). For example, the user may carry a device equipped with a Global Positioning System (GPS), and (with the user's permission) the system may use data from the GPS to keep track of the user's location. As another example, the user may participate in a check-in system, and the system may keep track of where the user checks in. The user's behavior may be observed in any manner (but, again, pursuant to appropriate permission obtained from the user in order to protect the user's interest in privacy).

At 104, the system may receive, from the user, information about the user's interests. For example, the user may self-report that the user is interested in the Seattle Mariners, tapas restaurants, Renaissance paintings, etc. The user may also indicate an interest in a specific event—e.g., a concert, a particular airline flight, etc.

At 106, a set of badges for the user is created. For example, a user might self-report his or her home address, an interest in a sports team, a flight that he or she is scheduled to take, etc. A badge may be created based on that self-reported interest (block 108). As another example, a badge may be created from inferences that the system draws about the user from the user based on the user's recurring behavior (block 110). For example, if the user frequently “checks in” at tapas restaurants, then the system may infer that the user is a tapas enthusiast. If the user frequently attends games for a particular sports team, the system may infer that the user is a fan of that sports team. If the user frequently travels a particular route by car, bus, or train, the system may infer that the route is part of the user's commute. (Of course, information about where the user checks in, what events the user attends, or what routes the user travels, may be obtained pursuant to appropriate permission in order to preserve the user's interest in privacy.) Based on any inferred attributes of the user, a badge may be created—e.g., a user who frequently checks in at tapas restaurants may be assigned the “tapas lover” badge. In addition to the foregoing, badges may be assigned based on any other attributes about the user, which may be ascertained in any appropriate manner (block 112).

At 114, a set of activities may be associated with a badge. For example, if the user has the “Seattle resident” badge, then activities associated with Seattle may be associated with the badge. Such activities might include checking the weather for Seattle, checking traffic reports for Seattle, notifying the user of new restaurants opening in Seattle, or any other activities that are geographically associated with the locale of Seattle. As another example, the user might receive a badge indicating that he or she is taking American Airlines flight 312 in the near future (e.g., the “AA312” badge). Activities associated with such a badge might include flight status reports, offering a chance to select seats, checking traffic on the way to the airport near the time of the flight, etc. If the user has the tapas lover badge, then activities associated with that badge might be alerting the user as to the opening of new tapas restaurants, displaying videos featuring information about tapas, displaying tapas recipes, etc.

It is noted that the act of associating an activity with a badge does not mean that the activity would have to be performed in all contexts. As discussed below, the actual activities that are performed based on the badge may be based on the context in which the user is interacting with a device. (E.g., the tapas lover badge might point the user to different tapas restaurants while the user is traveling with his or her smart phone, but might show the user a tapas recipe if the user is using a tablet in the kitchen.)

At 116, context triggers may be detected. Context triggers might include the user's location, the device that the user is using, whether the user is moving or stationary, the current time, whether the user is actively using a device at a particular time, what the user is doing on that device, or any other facts that make up the current context. At 118, an activity is chosen based on the detected context. For example, continuing with the tapas example above, if the user has the tapas lover badge and the user is traveling with his or her smart phone near a tapas restaurant, the phone might choose to alert the user that a tapas restaurant is nearby. If the user is watching a television program and a cooking show featuring tapas is on another channel, the system might display an alert on the television indicating that a tapas program is on, and might ask the user if he or she wants to switch channels or record the program. If the user is in the kitchen, the system might choose to display a tapas recipe. Any of these are examples of activities that could be chosen based on context. Some additional examples of activities include the following: A search could be performed, and the rankings of results could be altered based on a badge (e.g., for a user who has the tapas badge, the tapas restaurants could appear higher in the rankings). Or, results could be annotated with badge-based information, such as “this restaurant appears in the results because you like tapas.” Or, additional user interface elements could be displayed on a web page, a device home page, or on some other canvas.

At 120 the chosen activity is initiated on some device associated with the user.

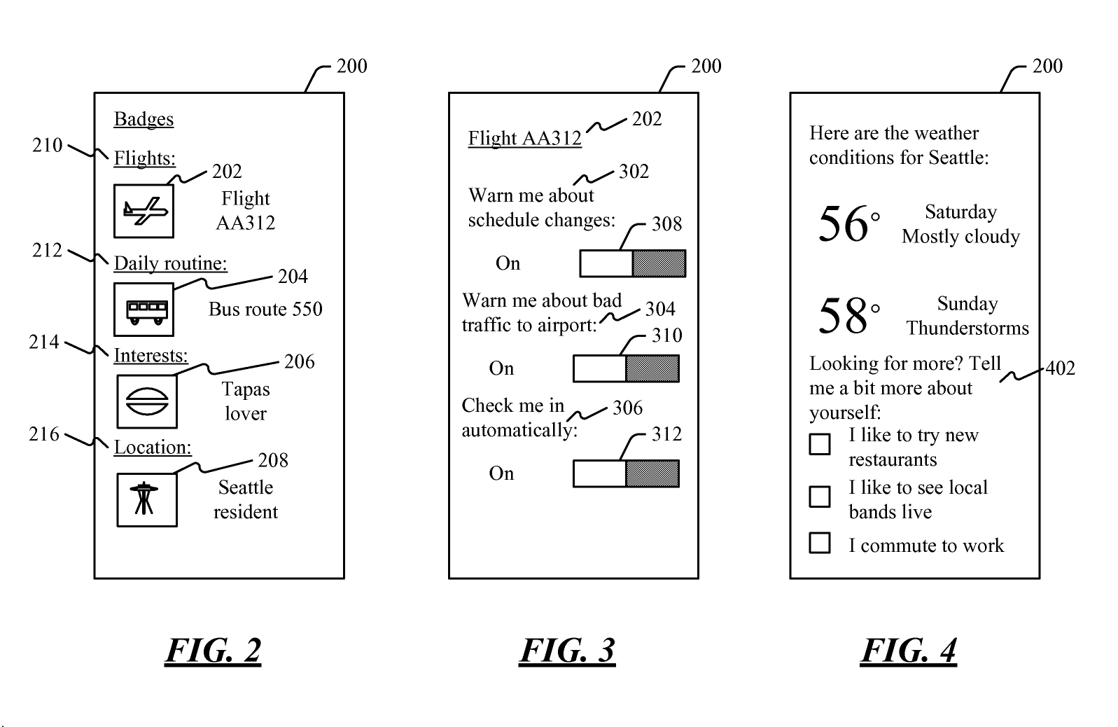

FIGS. 2-4 show example user interfaces that may be used with the systems and processes described herein. All of FIGS. 2-4 show example interfaces being displayed on a device 200 (which appears in all three figures), although the interface could be displayed on any appropriate device. The interface in FIG. 2 shows various badges. In the example shown, a user has badges 202, 204, 206, and 208. Badge 202 is the “AA312” badge (indicating that the user is associated with American Airlines flight 312). Badge 204 is the “bus route 550” badge, and badge 206 is the tapas enthusiast badge. As can be seen, badges can be associated with any aspect of the user, ranging from the specific to the general. Badge 202 might be assigned to the user because the user holds a ticket on a specific flight. Badge 204 might be assigned to the user because of the user's general commuting patterns. Badge 206 might be assigned to the user because of the user's expressed or inferred interest in tapas. Badge 208 might be assigned to the user because of the location of the user's residence. Badges can be assigned for any reason. The user interface shown in FIG. 2 may organize the user's badges by category (with categories 210, 212, 214, and 216 being shown by way of example). In the example shown, badges 202, 204, 206, and 208 are in categories 210, 212, 214, and 216, respectively. Due to space constraints in the drawing, each category is shown as having only one badge, although in an implementation any number of badges could be shown in each category. There could be any number of categories, and the specific categories shown in FIG. 2 are merely examples.

Each badge may be associated with a number of actions, some or all of which may be configured by the user. FIG. 3 shows an example interface that may be used to configure the actions associated with badge 202, the “AA312” badge.

The interface shown in FIG. 3 shows three actions, 302, 304, and 306, that could be associated with badge 202. One such action is “warn me about schedule updates.” Another action is “warn me about bad traffic to airport.” A third action is “check me in automatically.” There is a slider switch 308, 310, 312, next to each action, thereby giving the user the opportunity to say which, if any, of the actions listed the user wants associated with the badge. A given badge may start with a set of default actions, where the selection can be adjusted by the user. As noted above, regardless of which actions the user has chosen to have associated with the badge, the actual actions that are initiated in a given situation may depend on context.

FIG. 4 shows an example interface on device 200 in which a user sees certain information associated with a badge. The badge being used in FIG. 4 is the Seattle Resident badge (badge 208, shown in FIG. 2). In the example of FIG. 4, the information shown includes the Seattle weather, although any information could be shown. FIG. 4 depicts a situation in which the user is seeing relatively little information associated with the badge, perhaps because the user has not yet indicated what other information or actions he or she would like to associate with the badge. In the interface of FIG. 4, content 402 is shown to the user which explains to the user that more information could be shown and/or more actions initiated, if the user provides more information. For example, the user could indicate that he likes to try new restaurant, or likes to see local bands, or commutes to work. The way in which content 402 is phrased may suggest to the user that the user's choosing to provide certain information may result in the system being able to provide additional services that may be of interest to the user. In this way, the system encourages a voluntary value exchange: the user gives some information about himself, and the system uses that information to provide additional services to the user.

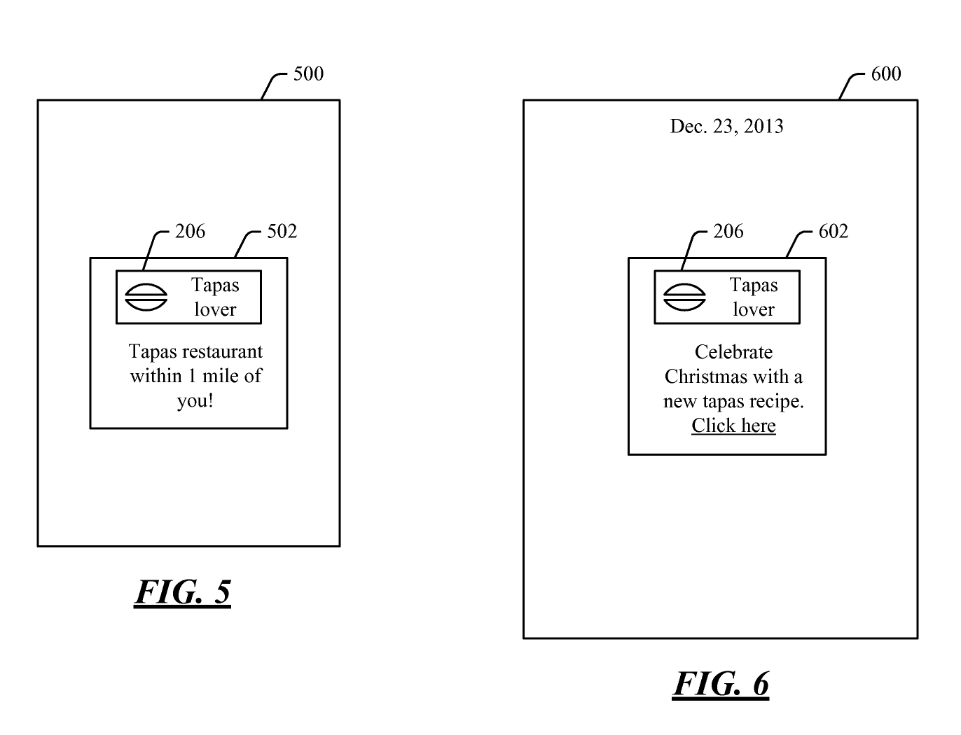

FIGS. 5 and 6 show example actions that may be performed based on a badge and based on context. In both FIGS. 5 and 6, the example badge in question is the tapas lover badge. Device 500 (shown in FIG. 5) is a smart phone, and device 600 (shown in FIG. 6) is a tablet. The context involved in deciding which action to initiate may include the device being used, but may also include factors such as the place at which the user is located, whether the user appears to be stationary or in motion, what other actions (if any) the user is doing at the moment with a given device, etc.

In FIG. 5, the user receives an alert 502. The action of providing the alert constitute an example of initiating an action based on a badge. The alert identifies itself as being presented based on the tapas lover badge 206. The alert indicates that there is a tapas restaurant within one mile. The action of presenting this alert (as opposed to performing some other action associated with the tapas lover badge) may be based on contextual information, such as the fact that the user is using a smart phone, the location of the smart phone, the fact that the user is traveling or moving with the smart phone, etc.

In FIG. 6, the user receives an alert 602. This alert, again, identifies the alert as being associated with the tapas lover badge 206. However, the alert tells the user to “celebrate Christmas with a new tapas recipe.” The context that caused the system to take the action of presenting this alert (as opposed to taking some other action associated with the tapas lover badge) may include the fact that the user is using tablet 600 (as opposed to smart phone 500 or some other device), the fact that it is two days before Christmas (the date on tablet 600 reads Dec. 23, 2013), the fact that the user is in the kitchen (which might be determined, for example, from GPS data used with the user's permission and/or from the user's WiFi connection), etc. In general, the badge is associated with various actions, and context determines which of those action is to be initiated based on the badge.

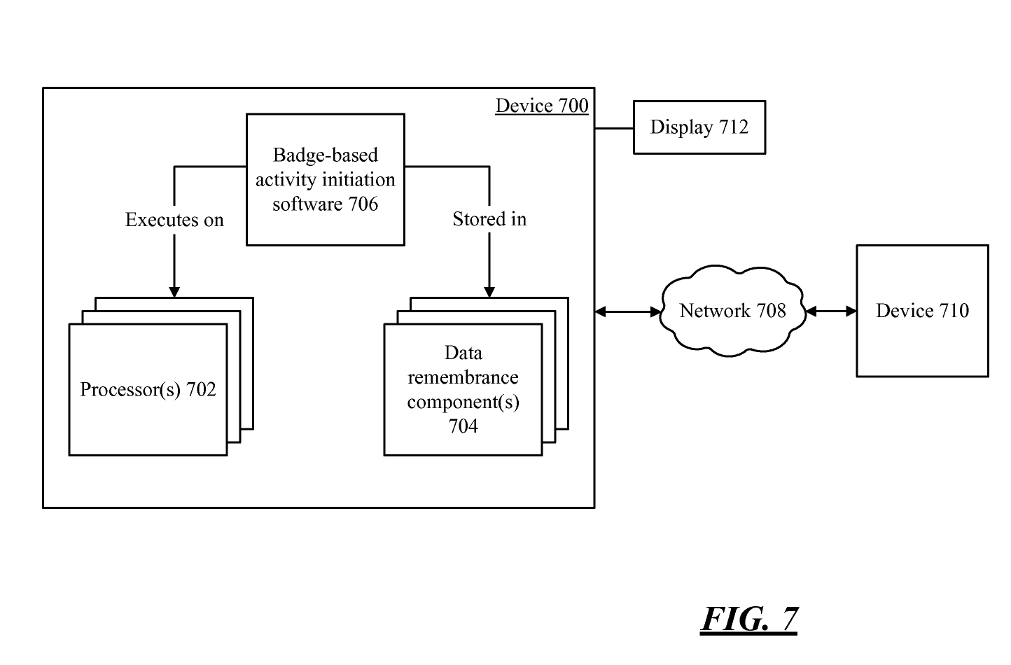

FIG. 7 shows an example environment in which aspects of the subject matter described herein may be deployed.

Device 700 includes one or more processors 702 and one or more data remembrance components 704. Processor(s) 702 are typically microprocessors, such as those found in a personal desktop or laptop computer, a server, a handheld computer, or another kind of computing device. Data remembrance component(s) 704 are components that are capable of storing data for either the short or long term. Examples of data remembrance component(s) 704 include hard disks, removable disks (including optical and magnetic disks), volatile and non-volatile random-access memory (RAM), read-only memory (ROM), flash memory, magnetic tape, etc. Data remembrance component(s) are examples of computer-readable storage media (or device-readable storage media). Device 700 may comprise, or be associated with, display 712, which may be a cathode ray tube (CRT) monitor, a liquid crystal display (LCD) monitor, or any other type of monitor.

Software may be stored in the data remembrance component(s) 704, and may execute on the one or more processor(s) 702. An example of such software is badge-based activity initiation software 706, which may implement some or all of the functionality described above in connection with FIGS. 1-6, although any type of software could be used. Software 706 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the device's processor(s) typifies the scenario depicted in FIG. 7, although the subject matter described herein is not limited to this example.

The subject matter described herein can be implemented as software that is stored in one or more of the data remembrance component(s) 704 and that executes on one or more of the processor(s) 702. As another example, the subject matter can be implemented as instructions that are stored on one or more computer-readable (or device-readable) media. Such instructions, when executed by a computer, device, or other machine, may cause the computer, device, or other machine to perform one or more acts of a method. The instructions to perform the acts could be stored on one medium, or could be spread out across plural media, so that the instructions might appear collectively on the one or more computer-readable (or device-readable) media, regardless of whether all of the instructions happen to be on the same medium.

Computer-readable (or device-readable) media includes, at least, two types of computer-readable media, namely computer storage media and communication media. Likewise, device-readable media includes, at least, two types of device-readable media, namely device storage media and communication media.

Computer storage media (or device storage media) includes volatile and non-volatile, removable and non-removable media implemented in any method or technology for storage of information such as computer readable instructions, data structures, program modules, or other data. Computer storage media (and device storage media) includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that may be used to store information for access by a computer or other type of device.

In contrast, communication media may embody computer readable instructions, data structures, program modules, or other data in a modulated data signal, such as a carrier wave, or other transmission mechanism. As defined herein, computer storage media does not include communication media. Likewise, device storage media does not include communication media.

Additionally, any acts described herein (whether or not shown in a diagram) may be performed by a processor (e.g., one or more of processors 702) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, device 700 may be communicatively connected to one or more other devices through network 708. Device 710, which may be similar in structure to device 700, is an example of a device that can be connected to device 700, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A device-readable medium that stores executable instructions to initiate activities, the executable instructions, when executed by a device, causing the device to perform acts comprising:
detecting a context of a user of said device;
accessing a set of activities associated with a badge assigned to said user;
choosing an activity from said set of activities, said choosing being based on said context; and
initiating said activity on said device.

2. The device-readable medium of claim 1, said acts further comprising:
receiving information concerning said user's interests; and
assigning said badge to said user based on said user's interests.

3. The device-readable medium of claim 1, said acts further comprising:
receiving information concerning said user's behavior; and
assigning said badge to said user based on a finding that said user's behavior is recurring.

4. The device-readable medium of claim 1, said acts further comprising:
assigning said badge to said user;
associating said set of activities with said badge; and
presenting, to said user, an interface that allows said user to activate and deactivate any of said activities.

5. The device-readable medium of claim 1, said acts further comprising:
offering said user a chance to add additional activities to said badge in exchange for answering questions about said user.

6. The device-readable medium of claim 1, said context comprising a type of said device, the activities that are initiated for said badge being different depending on which type of device is being used.

7. The device-readable medium of claim 1, said context comprising where said device is located and whether said device is moving at a time when said activity is initiated.

8. A method of initiating activities, the method comprising:
using a processor to perform acts comprising:
assigning a badge to a user;
associating a plurality of activities with said badge;
detecting that a trigger has occurred;
choosing an activity from said plurality of activities based on a context associated with said trigger; and
initiating said activity on a device that comprises said processor.

9. The method of claim 8, said acts further comprising:
receiving information concerning said user's interests, said badge being assigned to said user based on said user's interests.

10. The method of claim 8, said acts further comprising:
receiving information concerning said user's behavior, said badge being assigned to said user based on a finding that said user's behavior is recurring.

11. The method of claim 8, said acts further comprising:
presenting, to said user, an interface that allows said user to activate and deactivate any of said activities.

12. The method of claim 8, said acts further comprising:
offering said user a chance to add additional activities to said badge in exchange for answering questions about said user.

13. The method of claim 8, said context comprising a type of said device, the activities that are initiated for said badge being different depending on which type of device is being used.

14. The method of claim 8, said context comprising where said device is located and whether said device is moving at a time when said activity is initiated.

15. A device comprising:
a memory;
a processor; and
an component that is stored in said memory, that executes on said processor, that detects a context of a user of said device, that accesses a set of activities associated with a badge assigned to said user, that chooses an activity from said set of activities, said choosing being based on said context, and that initiates said activity on said device.

16. The device of claim 15, said component receiving information concerning said user's interests, said component assigning said badge to said user based on said user's interests.

17. The device of claiml5, said component receiving information concerning said user's behavior, said component assigning said badge to said user based on a finding that said user's behavior is recurring.

18. The device of claim 15, said component assigning said badge to said user, said component associating said set of activities with said badge, said component presenting, to said user, an interface that allows said user to activate and deactivate any of said activities.

19. The device of claim 15, said component offering said user a chance to add additional activities to said badge in exchange for answering questions about said user.

20. The device of claim 15, said context comprising a type of said device, the activities that are initiated for said badge being different depending on which type of device is being used.
